(19) United States
(12) Patent Application Publication
(10) Pub. No.: US 2017/0108647 A1
(43) Pub. Date: Apr. 20, 2017

(54) RIGHT-ANGLE WAVEGUIDE BASED ON SQUARE-HOLE-TYPE SQUARE-LATTICE PHOTONIC CRYSTAL AND DUAL COMPENSATION SCATTERING CYLINDERS WITH LOW REFRACTIVE INDEX

(71) Applicant: ZHENGBIAO OUYANG, SHENZHEN (CN)

(72) Inventors: Zhengbiao Ouyang, Shenzhen (CN); Hao Huang, Shenzhen (CN)

(21) Appl. No.: 15/395,946

(22) Filed: Dec. 30, 2016

Related U.S. Application Data
(63) Continuation of application No. PCT/CN2015/090891, filed on Sep. 28, 2015.

(30) Foreign Application Priority Data
Sep. 29, 2014 (CN) 201410515265.5

(51) Int. Cl. G02B 6/122; G02B 6/125

(52) U.S. Cl. CPC G02B 6/1225; G02B 6/125

(57) ABSTRACT

Disclosed in the present invention is a square-hole square-lattice photonic crystal orthogonal waveguide having low refractive index twin compensation scattering columns, being a photonic crystal consisting of a low refractive-index first medium column in a high refractive-index background medium arranged in a square crystal lattice, there being removed from said photonic crystal one row and one column of the low refractive-index first medium so as to form an orthogonal waveguide; columns of a second and a third low refractive-index medium are configured at two turning points respectively of said orthogonal waveguide; the second and third medium columns are compensation scattering columns; said second and third medium compensation scattering columns are low refractive-index medium columns or air holes; the first medium column is a low refractive-index medium square column or square air hole. The structure of the present invention features very low reflectivity and an extremely high rate of data transmission, and facilitates integration of large scale light paths, thus affording wider space for application of photonic crystals.

### CROSS-REFERENCE TO RELATED APPLICATIONS

This application is a continuation of International Patent Application No. PCT/CN2015/090891 with a filing date of Sep. 28, 2015, designating the United States, now pending, and further claims priority to Chinese Patent Application No. 201410515265.5 with a filing date of Sep. 29, 2014. The content of the aforementioned applications, including any intervening amendments thereto, are incorporated herein by reference.

### TECHNICAL FIELD

The present invention relates to a photonic crystal waveguide, and in particular relates to a right-angle waveguide based on a square-hole-type square-lattice photonic crystal and dual compensation scattering cylinders with low refractive index.

### BACKGROUND OF THE PRESENT INVENTION

In 1987, E. Yablonovitch from a Bell laboratory of the United States, who was discussing about how to inhibit spontaneous radiation, and S. John from Princeton University, who was discussing about a photon localization, respectively and independently proposed the concept of photonic crystal (PhC). The PhC is a material structure formed in a way that dielectric materials are periodically arranged in space and an artificial crystal which is composed of two or more than two materials with different dielectric constants. The PhC has stronger and flexible control capability for propagation of light and high transmission efficiency for linear transmission and sharp right-angle transmission. If a line defect is introduced into the structure of the PhC, a light guiding channel is created, called as a photonic crystal waveguide (PCW). Even if the wavegulde has a 90-degree corner, the waveguide only has a very little loss. Completely different from conventional wave guides with basic total internal reflection, the PCW mainly utilizes a waveguide effect of a defect state; a new photon state is formed inside a photonic band gap (PBG) due to the introduction of the defect, while the photon state density deviating from the defect state is zero. Therefore, the PCW realizes light transmission in a defect mode, without causing mode leakage. The PCW is a basic device for forming optical integrated circuits, the right-angle PCW can improve the integration level of optical circuits, and the research related to right-angle PCWs has important significance for the development of the optical integrated circuits.

### SUMMARY OF PRESENT INVENTION

The present invention aims at overcoming the defects in the prior art to provide a right-angle waveguide based on a square-hole-type square-lattice photonic crystal and dual compensation scattering cylinders with low refractive index, and the right-angle waveguide has extremely low reflectance and very high transmission rate.

To achieve the above purpose the prevent invention is realized through a technical solution below.

The right-angle waveguide based on said square-hole-type square-lattice photonic crystal and the dual compensation scattering cylinders with low refractive index according to the present invention is built in a PhC formed from first dielectric cylinders with low refractive index arranged in a background dielectric with high refractive index according to a square lattice. In the PhC, one row and one column of said first dielectric cylinders with low refractive index are removed to form said right-angle waveguide. A second and a third dielectric cylinders with low refractive index are respectively arranged at two corners of said right-angle waveguide; said second and said third dielectric cylinders are respectively compensation scattering cylinders; said second and said third dielectric compensation scattering cylinders are dielectric cylinders with low refractive index or air holes; and said first dielectric cylinders are square cylinders with low refracture index or square air holes.

Said second and said third dielectric compensation scattering cylinders are isosceles right triangle cylinders with low refractive index or air holes, arch shaped cylinders with low refractive index or air holes, square cylinders with low refractive index or air holes, triangular cylinders with low refractive index or air holes, polygonal cylinders of more than three sides with low refractive index or air holes, or cylinders with low refractive index, of which the outlines of the cross sections are smooth closed curves or air holes.

Said second and said third dielectric compensation scattering cylinders are respectively the isosceles right triangle cylinders with low refractive index or air holes.

The material of said first dielectric cylinders with high refractive index is Si, gallium arsenide, titan dioxide, or a different dielectric with refractive index of more than 2.

The material of said first dielectric cylinders with high refractive index is Si, and the refractive index of Si is 3.4.

The material of said background dielectric with low refractive index is air, vacuum, magnesium fluoride, silicon dioxide or a different dielectric with a refractive index of less than 1.6.

Said background dielectric with low refractive index is air.

Said right-angle waveguide is a waveguide operating in a transverse electric (TE) mode.

The area of the structure of said right-angle waveguide is more than or equal to 7a*7a, wherein a is the lattice constant of the PhC.

A PhC waveguide device of the present invention can be widely applied in various photonic or optical integrated devices. Compared with the prior art, said right-angle PCW according to the present invention has the positive effects below:
1. Said right-angle waveguide based on said square-hole-type square-lattice photonic crystal and the dual compensation scattering cylinders with low refractive index according to the present invention has extremely low reflectance and very high transmission rate, thereby providing a greater space for application of said right-angle PCW;
   2. The structure of the present invention is based on multiple scattering theory, phase and amplitude compensations for reducing the reflectance and improving the transmission rate of optical waves transmitted in said structure is realized by said dual dielectric compensation scattering cylinders with low refractive index, so as to reduce the reflectance and improve the transmission rate, and therefore, said structure can realize low reflectance and high transmission rate;
3. Said right-angle waveguide based on the square-hole-type square-lattice photonic crystal and the dual compensation scattering cylinders with low refractive index according to the present invention can be used in design for large-scale optical integrated circuits; the optical circuits are concise and are convenient to design, and said right-angle waveguide facilitates large-scale integration of optical circuits;
4. Said right-angle waveguide based on the square-hole-type square-lattice photonic crystal and the dual compensation scattering cylinders with low refractive index according to the present invention can realize connection and coupling of different elements in the optical circuits and among different optical circuits, thereby being favorable to lowering the cost.

### DESCRIPTION OF THE DRAWINGS

FIG. 1 is the schematic diagram of the core region of the structure of the right-angle waveguide based on a square-hole-type square-lattice photonic crystal and dual compensation scattering cylinders with low refractive index of the present invention;

FIG. 2 is the normalized frequency-transmission characteristic diagram of the right-angle waveguide based on the square-hole-type square-lattice photonic crystal and the dual compensation scattering cylinders with low refractive index according to the present invention.

### DETAILED DESCRIPTION OF PREFERRED EMBODIMENTS

Specific implementation manners of the present invention are further illustrated in combination with the drawings.

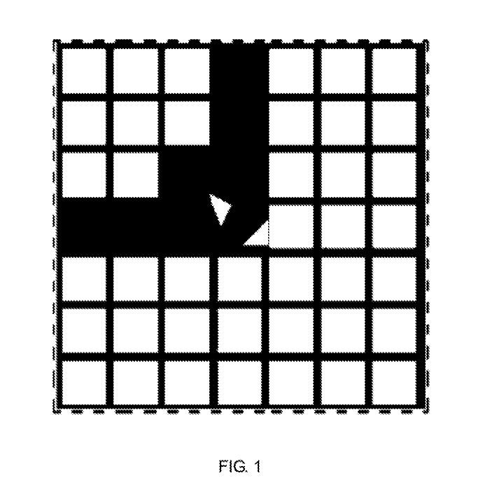

As shown in FIG. 1, a right-angle waveguide based on a square-hole-type square-lattice photonic crystal and dual compensation scattering cylinders with low refractive index according to the present invention: the photonic crystal (PhC) is formed from said first dielectric cylinders with low refractive index arranged in a background dielectric with high refractive index according to square lattice. The material of the background dielectric with high refractive index is adopted as Si, gallium arsenide, titanium dioxide, or a dielectric with refractive index of more than 2; and the material of the background dielectric with low refractive index is adopted as air, vacuum, magnesium fluoride, silicon dioxide, or a dielectric with refractive index of less than 1.6. In said PhC, one row and one column of said first dielectric cylinders with low refractive index are removed to form the right-angle waveguide. A second and a third dielectric compensation scattering cylinders with low refractive index are respectively arranged at two corners of the right-angle waveguide, said second and said third dielectric compensation scattering cylinders are respectively dielectric cylinders with low refractive index or air holes, and the compensation reflected waves generated by the second and third dielectric compensation scattering cylinders are offset by the intrinsic reflected waves in the waveguide; said compensation scattering dielectric cylinders are further adopted as: isosceles right triangle cylinders with low refractive index or air holes, arch shaped cylinders with low refractive index or air holes, square cylinders with low refractive index or air holes, triangular cylinders with low refractive index or air holes, polygonal cylinders with low refractive index or air holes or cylinders with low refractive index, or further a cylinder, of which the outlines of the cross section is a smooth closed curve or air holes.

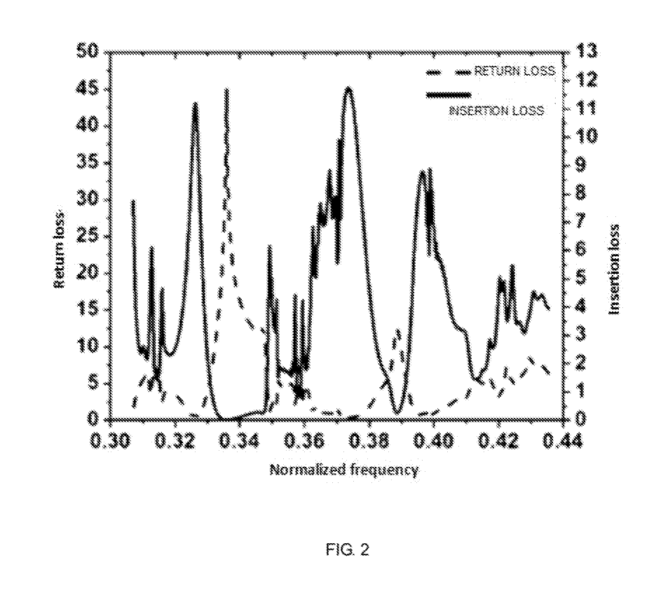

Six embodiments are shown below according to the above result:
Embodiment 1: the lattice constant of said square-lattice PhC is a; said first dielectric cylinders with low refractive index are square-shaped air cylinders (or known as square air holes); the side length of each square air hole is 0.83 a: the polarization of optical waves transmitted in the waveguide is TE form; said second and said third dielectric compensation scattering cylinders are respectively air cylinders or known as air holes; said second and said third dielectric compensation scattering air cylinders are respectively adopted as isosceles right triangle air cylinders or air holes; the length of the right-angle side of said isosceles right triangle compensation scattering dielectric cylinder with low refractive index at the upper left corner is 0.46029 a; the displacements of said compensation scattering dielectric cylinder in the X direction and in the Z direction measured from the original benchmark point are respectively 1.08486 a and 0.21121 a, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of said isosceles right triangle compensation scattering dielectric cylinder with refractive index at the lower right corner is 0.48022 a; the displacements of said compensation scattering dielectric cylinder in the X direction and in the Z direction measured from the original benchmark point are respectively 0.15476 a and 0.2018 a, and the rotation angle is 269.58 degrees; the position of an optical source measured from the coordinate origin in the X direction and in the Z direction is (−6.00 a, 0); and the initial phase of incident light (the optical source) is 169.8 degrees. The background dielectric with high refractive index is Si, and the refractive index of Si is 3.4; and the dielectric with low refractive index is air. The structure size of the right-angle waveguide formed in the PhC is 15 a*15 a, a return loss spectrum and an insertion loss spectrum of the right-angle waveguide formed in the PhC are then obtained and shown in FIG. 2, the horizontal axis part of the figure is the operating frequency of the structure, the longitudinal axis part of the figure indicates transmission, the dash line in the figure indicates the return loss of the structure (defined as: LR=−10 log (PR/PI), while the solid line in the figure indicates the insertion loss (defined as: LI=−10 log (PT/PI), wherein PI is the incident power of the structure, PR is the reflection power of the structure, and PT is the transmission power of the structure. At the normalized frequency of 0.336(ωa/2πc), the maximum return loss and the minimum insertion loss of the right-angle waveguide formed in the PhC are 45.11 dB and 0.0004 dB.
Embodiment 2: the lattice constant a of said square-lattice PhC is 0.5208 μm, so that the optimal normalized wavelength is 1.4 μm; said first dielectric cylinders with low refractive index are adopted as square air cylinders; the side length of each square air hole is 0.432264 μm; the polarization of optical waves transmitted in the waveguide is TE form; said second and said third dielectric compensation scattering air cylinders are respectively adopted as isosceles right triangle air cylinders; the length of the right-angle side of said isosceles right triangle compensation scattering dielectric cylinder with low refractive index at the upper left corner is 0.24 μm; the displacements of said compensation scattering dielectric cylinder in the X direction and in the Z direction measured from the original benchmark point are respectively 0.565 μm and 0.11 μm, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of the isosceles right triangle compensation scattering dielectric cylinder with low refractive index at the lower right corner is 0.2501 μm; the displacements of said compensation scattering dielectric cylinder in the X direction and in the Z direction measured from the original benchmark point are respectively 0.0806 μm and 0.1051 μm, and the rotation angle is 269.58 degrees; the position of an optical source measured from the coordinate origin in the X direction and in the Z direction is (−6.00 a, 0); and the initial phase of incident light (the optical source) is 169.8 degrees. The background dielectric with high refractive index is Si, and the refractive index of Si is 3.4; and the dielectric with low refractive index is air. The structure size of the right-angle waveguide formed in the PhC is 15 a*15 a, and the return loss and the insertion loss of the right-angle waveguide formed in the PhC are then 0.37209 dB and 10.85587 dB.

Embodiment 3: the lattice constant a of said square-lattice PC is 0.5208 μm, so that the optimal normalized wavelength is 1.55 μm; said first dielectric cylinders with low refractive index are adopted as square air cylinders; the side length of each square air hole is 0.432264 μm; the polarization of optical waves transmitted in the waveguide is TE form; said second and said third dielectric compensation scattering air cylinders are respectively adopted as isosceles right triangle air cylinders; the length of the right-angle side of said isosceles right triangle compensation scattering dielectric cylinder with low refractive index at the upper left corner is 0.24 μm; the displacements of said compensation scattering dielectric cylinder in the X direction and in the Z direction measured from the original benchmark point are respectively 0.565 μm and 0.11 μm, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of the isosceles right triangle compensation scattering dielectric cylinder with low refractive index at the lower right corner is 0.2501 μm; the displacements of said compensation scattering dielectric cylinder in the X direction and in the Z direction measured from the original benchmark point are respectively 0.0806 μm and 0.1051 μm, and the rotation angle is 269.58 degrees; the position of an optical source measured from the coordinate origin in X direction and in the Z direction is (−3.1248, 0)(μm); and the initial phase of incident light (the optical source) is 169.8 degrees. The background dielectric with high refractive index is Si, and the refractive index of Si is 3.4; and the dielectric with low refractive index is air. The structure size of the right-angle waveguide formed in the PhC is 15 a*15 a. At the normalized frequency of 0.336(ωa/2πC), the maximum return loss and the minimum insertion loss of the right-angle waveguicle formed in the PhC are respectively 45.11 dB and 0.0004 dB.
Embodiment 4: the lattice constant a of said square-lattice PhC is 0.336 μm, so that the optimal normalized wavelength is 1.00 μm: said first dielectric cylinders with low refractive index are adopted as square air cylinders; the side length of each square air hole is 0.27888 μm; the polarization of optical waves transmitted in said waveguide is TE form; said second and said third dielectric compensation scattering air cylinders are respectively adopted as isosceles right triangle air cylinders; the length of the right-angle side of the isosceles right triangle compensation scattering dielectric cylinder with low refractive index at the upper left corner is 0.154657 μm; the displacements of said compensation scattering dielectric cylinder in the X direction and in the Z direction measured from the original benchmark point as the benchmark are respectively 0.364513 μm and 0.070967 μm, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of the isosceles right triangle compensation scattering dielectric cylinder with low refractive index at the lower right corner is 0.161354 μm; the displacements of said compensation scattering dielectric cylinder in the X direction and in the Z direction measured from the original benchmark point are respectively 0.051999 μm and 0.067805 μm, and the rotation angle is 269.58 degrees; the position of an optical source measured from the coordinate origin in the X direction and in the Z direction is (−2.016, 0)(μm); and the initial phase of incident light (the optical source) is 169.8 degrees. The background dielectric with high refractive index is Si, and the refractive index of Si is 3.4; and the dielectric with low refractive index is air. The structure size of the right-angle waveguide formed in the PhC 15 a*15 a. At the normalized frequency of 0.336(ωa/2πc), the maximum return loss and the minimum insertion loss of the right-angle waveguide formed in the PhC are respectively 45.11 dB and 0.0004 dB.
Embodiment 5: the lattice constant a of said square-lattice PC is 0.49728 μm, so that the optimal normalized wavelength is 1.48 μm; said first dielectric cylinders with low refractive index are adopted as square air cylinders; the side length of each square air hole is 0.412742 μm; the polarization of optical waves transmitted in said waveguide is TE form; said second and said third dielectric compensation scattering air cylinders are respectively adopted as isosceles right triangle air cylinders; the length of the right-angle side of the isosceles right triangle compensation scattering dielectric cylinder with low refractive index at the upper left corner is 0.228893 μm; the displacements of said compensation scattering dielectric cylinder in the X direction and in the Z direction measured from the original benchmark point are respectively 0.539479 μm and 0.105031 μm, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of the isosceles right triangle compensation scattering dielectric cylinder with low refractive index at the lower right corner is 0.238804 μm; the displacements of said compensation scattering dielectric cylinder in the X direction and in the Z direction measured from the original benchmark point are respectively 0.076959 μm and 0.100351 μpm, and the rotation angle is 269.58 degrees: the position of an optical source measured from the coordinate origin in the X direction and in the Z direction is (−2.98368, 0) (μm); and the initial phase of incident light (the optical source) is 169.8 degrees. The background dielectric with high refracture index is Si, and the refractive index of Si is 3.4; and the dielectric with low refractive index is air. The structure size of the right-angle waveguide formed in the PhC is 15 a*15 a. At the normalized frequency of 0.336(ωa/2πc), the maximum return loss and the minimum insertion loss of the right-angle waveguide formed in the PhC are respectively 45.11 dB and 0.0004 dB.
Embodiment 6: the lattice constant a of said square-lattice PhC is 168 μm, so that the optimal normalized wavelength is 500 μm; said first dielectric cylinders with low refractive index are adopted as square-shaped air cylinders; the side length of each square air hole is 139.44 μm; the polarization of optical waves transmitted in the waveguide is TE form; the second and the third dielectric compensation scattering air cylinders are respectively adopted as isosceles right triangle air cylinders; the length of the right-angle side of the isosceles right triangle compensation scattering dielectric cylinder with low refractive index at the upper left corner is 77.32872 μm; the displacements of said compensation scattering dielectric cylinder in the X direction and in the Z direction measured from the original benchmark point are respectively 182.2565 μm and 35.48328 μm, and the rotation angle is 205.8 degrees; the reference axis of the rotation angle is the horizontal right-hand axis, and the rotation direction is the clockwise direction; the X axis is in the horizontal right-hand direction, and the Z axis is in a vertical upward direction; the length of the right-angle side of the isosceles right triangle compensation scattering dielectric cylinder with low refractive index at the lower right corner is 80.67696 μm; the displacements of said compensation scattering dielectric cylinder in the X direction and in the Z direction measured from the original benchmark point are respectively 25.99968 μm and 33.9024 μm, and the rotation angle is 269.58 degrees; the position of an optical source measured from the coordinate origin in the X direction and in the Z direction is (−1008, 0)(μm); and the initial phase of incident light (the optical source) is 169.8 degrees. The background dielectric with high refractive index is Si, and the refractive index of Si is 3.4; and the dielectric with low refractive index is air. The structure size of the right-angle waveguide formed in the PhC is 15 a*15 a. At the normalized frequency of 0.336(ωa/2πc), the maximum return loss and the minimum insertion loss of the right-angle waveguide formed in the PhC are respectively 45.11 dB and 0.0004 dB.

The above detailed description is only for clearly understanding the present invention and should not be taken as an unnecessary limit to the present invention. Therefore, any modification made to the present invention is apparent for those skilled in the art.

We claim:

1. A right-angle waveguide based on a square-hole-type square-lattice photonic crystal and dual compensation scattering cylinders with low refractive index, characterized in that: said right-angle waveguide is built in a photonic crystal (PhC) formed from first dielectric cylinders with low refractive index arranged in a background dielectric with high refractive index according to square lattice; in the PhC, one row and one column of said first dielectric cylinders with low refractive index are removed to form the right-angle waveguide; a second and a third dielectric cylinders with low refractive index are respectively arranged at two corners of the right-angle waveguide; said second and said third dielectric cylinders are respectively compensation scattering cylinders; said second and said third dielectric compensation scattering cylinders are dielectric cylinders with low refractive index or air holes; and said first dielectric cylinders are square cylinders with low refractive index or square air holes.

2. The right-angle waveguide based on said square-hole-type square-lattice photonic crystal and said dual compensation scattering cylinders with low refractive index according to claim 1, characterized in that: said second and said third dielectric compensation scattering cylinders are isosceles right triangle cylinders with low refractive index or air holes, arch shaped cylinders with low refractive index or air holes, square cylinders with low refractive index or air holes, triangular cylinders with low refractive index or air holes, polygonal cylinders with low refractive index of more than three sides or air holes, or cylinders with low refractive index, of which the outlines of the cross sections are smooth closed curves or air holes.

3. The right-angle waveguide based on said square-hole-type square-lattice photonic crystal and said dual compensation scattering cylinders with low refractive index according to claim 2, characterized in that: said second and said third dielectric compensation scattering cylinders are respectively the isosceles sight triangle cylinders with low refractive index or air holes.

4. The right-angle waveguide based on said square-hole-type square-lattice photonic crystal and said dual compensation scattering cylinders with low refractive index according to claim 1, characterized in that: the material of said first dielectric cylinders with high refractive index is Si, gallium arsenide, titanium dioxide, or a different dielectric with refractive index of more than 2.

5. The right-angle waveguide based on said square-hole-type square-lattice photonic crystal and said dual compensation scattering cylinders with low refractive index according to claim 4, characterized in that: the material of said first dielectric cylinders with high refractive index is silica, and the refractive index of Si is 3.4.

6. The right-angle waveguide based on said square-hole-type square-lattice photonic crystal and said dual compensation scattering cylinders with low refractive index according to claim 1, characterized in that: the material of said background dielectric with low refractive index is air, vacuum, magnesium fluoride, silicon dioxide, or a different dielectric with refractive index of less than 1.6.

7. The right-angle waveguide based on said square-hole-type square-lattice photonic crystal and said dual compensation scattering cylinders with low refractive index according to claim 6, characterized in that: said background dielectric with low refractive index is air.

8. The right-angle waveguide based on said square-hole-type square-lattice photonic crystal and said dual compensation scattering cylinders with low refractive index according to claim 1, characterized in that: the right-angle waveguide is a waveguide operating in a TE mode.

9. The right-angle waveguide based on said square-hole-type square-lattice photonic crystal and said dual compensation scattering cylinders with low refractive index according to claim 1, characterized in that: the area of the structure of said right-angle waveguide is more than or equal to 7 a*7 a, and a is the lattice constant of the PhC.
